(19) United States
(12) Patent Application Publication
(10) Pub. No.: US 2014/0324631 A1
(43) Pub. Date: Oct. 30, 2014

(54) SYSTEMS AND METHODS FOR CONNECTING CONTENT PROVIDERS WITH POTENTIAL PURCHASERS

(71) Applicant: Acquisit LLC, Lewes, DE (US)

(72) Inventors: Orlando Edwards, Yeadon, PA (US); Andrew Oikle, Austin, TX (US)

(21) Appl. No.: 14/265,086

(22) Filed: Apr. 29, 2014

Related U.S. Application Data
(60) Provisional application No. 61/816,948, filed on Apr. 29, 2013.

(51) Int. Cl. G06Q 30/06

(52) U.S. Cl. CPC G06Q 30/0625
USPC 705/26.62

(57) ABSTRACT

Systems and methods for connecting content providers with potential purchasers are described. A method may include receiving content submissions from first users that includes contact information, content, information regarding the content, and descriptive keywords regarding the content. The method may further include directing a storage device to store the content submissions in a database configured to be indexed for searching search criteria based upon the content submissions and receiving search requests from second users that includes request criteria corresponding to a desired search result. The method may further include searching the database for search criteria corresponding to the request criteria to obtain content submissions, directing a display to display the content submissions, and receiving a selection input that corresponds to an indication that one of the content submissions is desired. The method may further include directing the display to display information corresponding to the desired content submissions.

### CROSS-REFERENCE TO RELATED APPLICATION

This application claims the priority benefit of U.S. Provisional Patent Application No. 61/816,948, filed Apr. 29, 2013 and entitled “Systems and Methods for Providing a Networked Evaluation,” which is incorporated herein by reference in its entirety.

### BACKGROUND

Use of the Internet has become increasingly commonplace because it provides users with an ability to interact with a wide variety of other individuals and entities all over the globe. The Internet has thus been used as a tool for collaboration purposes. However, a tool that harnesses the capabilities of the Internet in such a way that content creators can submit their content to be easily viewed by potential purchasers of the content, industry professionals, talent acquisition individuals, and/or the like has not been developed.

### SUMMARY

In an embodiment, a method of providing a networked evaluation may include receiving, by a processor, one or more content submissions from one or more first users. The one or more content submissions may include one or more of the following: a name, contact information, content, information regarding the content, and one or more descriptive keywords regarding the content. The method may further include directing, by the processor, a storage device to store the one or more content submissions in a database configured to be indexed for searching one or more search criteria based upon the one or more content submissions and receiving, by the processor, one or more search requests from each of one or more second users. Each search request may include one or more request criteria corresponding to a desired search result. For each of the one or more second users, the method may further include searching, by the processor, the database for one or more search criteria that correspond to the one or more request criteria to obtain one or more content submissions, directing, by the processor, a display to display the one or more content submissions, and receiving, by the processor, a selection input. The selection input may correspond to an indication by the second user that one of the one or more content submissions is desired. For each of the one or more second users, the method may further include directing, by the processor, the display to display information corresponding to the desired content submissions.

In an embodiment, a system for providing a networked evaluation may include a storage device configured to store one or more content submissions in a database configured to be indexed for searching one or more search criteria based upon the one or more content submissions, a processor, and a non-transitory, processor-readable storage medium in communication with the processor. The non-transitory, processor-readable storage medium may include one or more programming instructions that, when executed, cause the processor to receive the one or more content submissions from one or more first users. The one or more content submissions may include one or more of the following: a name, contact information, content, information regarding the content, and one or more descriptive keywords regarding the content. The non-transitory, processor-readable storage medium may further include one or more programming instructions that, when executed, cause the processor to direct the storage device to store the one or more content submissions in the database and receive one or more search requests from each of one or more second users. Each search request may include one or more request criteria corresponding to a desired search result. The non-transitory, processor-readable storage medium may further include one or more programming instructions that, when executed, cause the processor to, for each of the one or more second users, search the database for one or more search criteria that correspond to the one or more request criteria to obtain one or more content submissions, direct a display to display the one or more content submissions, and receive a selection input. The selection input may correspond to an indication by the second user that one of the one or more content submissions is desired. The non-transitory, processor-readable storage medium may further include one or more programming instructions that, when executed, cause the processor to direct the display to display information corresponding to the desired content submissions.

### BRIEF DESCRIPTION OF THE DRAWINGS

FIG. 1 depicts a block diagram of an illustrative network of one of more users with a system according to an embodiment.

FIG. 2 depicts a flow diagram of an illustrative method of connecting content providers with potential purchasers according to an embodiment.

FIG. 3 depicts a flow diagram of an illustrative method of registering a user according to an embodiment.

FIG. 4 depicts a block diagram of illustrative modules according to an embodiment.

FIG. 5 depicts a flow diagram of an illustrative method of managing content according to an embodiment.

FIG. 6 depicts a flow diagram of an illustrative method of searching for and providing content to a user according to an embodiment.

FIG. 7 depicts a block diagram of illustrative internal hardware of a computing device according to an embodiment.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

The term “about,” as used herein, refers to variations in a numerical quantity that can occur, for example, through measuring or handling procedures in the real world; through inadvertent error in these procedures; through differences in the manufacture, source, or purity of compositions or reagents; and the like. Typically, the term “about” as used herein means greater or lesser than the value or range of values stated by 1/10 of the stated values, e.g., ±10%. For instance, a concentration value of about 30% can mean a concentration between 27% and 33%. The term “about” also refers to variations that would be recognized by one skilled in the art as being equivalent so long as such variations do not encompass known values practiced by the prior art. Each value or range of values preceded by the term “about” is also intended to encompass the embodiment of the stated absolute value or range of values. Whether or not modified by the term “about,” quantitative values recited in the claims include equivalents to the recited values, e.g., variations in the numerical quantity of such values that can occur, but would be recognized to be equivalents by a person skilled in the art.

The following terms shall have, for the purposes of this application, the respective meanings set forth below.

An “electronic device” refers to a device, such as, for example, a mobile device, a computing device, a server, and one or more components thereof. In some embodiments, the electronic device includes a processor and a tangible, non-transitory, computer-readable memory. The memory may contain programming instructions that, when executed by the processor, cause the computing device to perform one or more operations according to the programming instructions. In some embodiments, the electronic device may be connected to a communications network, such as, for example, the Internet, an intranet, a personal area network, a home area network, a storage area network, a campus area network, a backbone network, a metropolitan area network, a wide area network, a virtual private network, and/or the like.

A “mobile device” refers to an electronic device that is generally portable in size and nature or is capable of being operated while in transport. Accordingly, a user may transport a mobile device with relative ease. Examples of mobile devices include, but are not limited to, pagers, cellular phones, feature phones, smartphones, personal digital assistants (PDAs), cameras, tablet computers, phone-tablet hybrid devices (e.g., “phablets”), laptop computers, netbooks, ultrabooks, global positioning satellite (GPS) navigation devices, in-dash automotive components, media players, watches, handheld imaging devices, personal medical devices, and/or the like.

A “computing device” is an electronic device and/or a mobile device, such as, for example, a computer or components thereof. The computing device may generally contain a memory or other storage device for housing programming instructions, data or information regarding a plurality of applications, data or information regarding a plurality of electronic devices and/or the like. The programming instructions may be in the form of an application environment, as described in greater detail herein, and/or contain one or more modules, such as software modules for carrying out tasks as described in greater detail herein. At least a portion of the data may be contained in a database, which is stored in the memory or other storage device. In some embodiments, the database may be a remote database that is separate from the computing device. The data may optionally be secured by any method now known or later developed for securing data. The computing device may further be in operable communication with one or more electronic devices. The communication between the computing device and each of the one or more electronic devices may further be secured by any method now known or later developed for securing transmissions or other forms of communication.

A “server” is a computing device or component thereof that generally provides data storage capabilities for one or more computing devices. The server can be independently operable from other computing devices and may optionally be configured to store data in a database, a memory, or another storage device. The server may optionally contain one or more programming instructions, such as programming instructions in the form of the operating environment, as described in greater detail herein, and/or one or more modules, such as software modules for carrying out processes as described in greater detail herein. The server may have one or more security features to ensure the security of data stored within the memory or other storage device. Examples of security features may include, but are not limited to, encryption features, authentication features, password protection features, redundant data features, and/or any other security features now known or later developed. The server may optionally be in operable communication with any of the electronic devices and/or computing devices described herein and may further be secured by any method now known or later developed for securing transmissions or other forms of communication.

An “application environment” is an embodiment of programming instructions that direct the various components of each electronic device to execute a plurality of operations, such as, for example, those described in more detail herein. The application environment may generally provide a means for communicating with one or more electronic devices, whether or not explicitly described herein, a means for obtaining data, a means for compiling data, a means for organizing data, a means for transmitting data, a means for performing calculations and a means for completing other tasks, as may be described in greater detail herein.

The present disclosure is directed to systems and methods designed to connect independent motion picture producers with industry professionals seeking to make a film or talent acquisition for their respective companies. Particularly, the systems and methods described herein may provide a forum for motion picture producers to showcase their content and/or their abilities to industry professionals. In addition, the systems and methods described herein may provide an industry professional that is interested in a particular motion picture producer and/or a producer's content with an ability to contact, negotiate with, or purchase content from the motion picture producer.

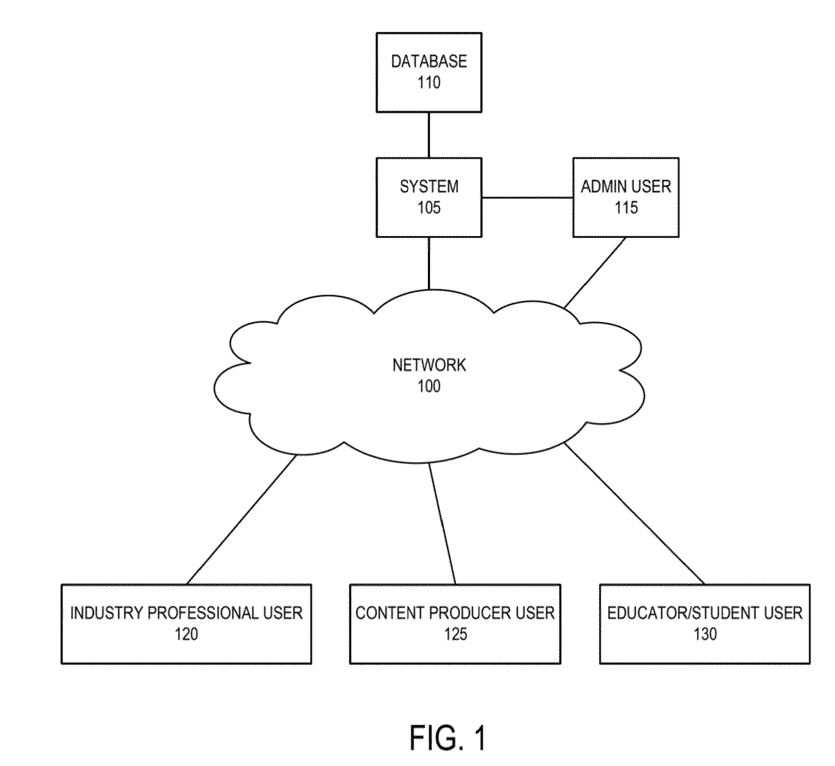

FIG. 1 depicts a block diagram of the various relationships between one or more users and/or systems described herein. For example, each user, such as an industry professional user 120, a content producer user 125, an educator/student user 130, and an administrative user 115 may connect to a system 105 via a network 100. In addition, the various users 115, 120, 125, 130 may connect to each other via the network 100, as described in greater detail herein. In some embodiments, an administrative user 115 may directly connect to the system 105, thereby bypassing a connection via the network 100.

The industry professional user 120 may generally be a person or an entity that provides content for mass consumption. Illustrative industry professional users may include, but are not limited to, movie studios, television studios, publishing houses, and/or employees and representatives thereof, such as a studio executive, a television executive, a publishing executive, and/or the like. Other illustrative industry professional users may include a talent agent, a manager, a public relations (PR) representative, a film festival organizer or employee, and a sales agent.

When interacting with the system 105, an industry professional user 120 may screen entire films and/or their corresponding trailers. In addition, an industry professional user 120 may exchange messages with one or more other users. If an industry professional user 120 is interested in the film(s) they've screened, the user can inquire about the films' acquisition prospects or possible representation of the talent involved in the film. Industry professional users 120 who are sales agents representing films to be acquired by a distributor may upload films in their company portfolios to be screened by other “acquisition” personnel representing other third-party companies, such as other industry professional users 120.

The content producer user 125 may generally be a person or group of persons that create media content. Illustrative content producer users 125 may include, for example, a filmmaker, a producer, a director, a writer, an actor, a photographer, a crew member, and/or the like. A content producer may be an independent motion picture producer, and thus the terms are used interchangeably herein. The content is not limited by this disclosure, and may generally be any content that is produced, particularly creative content. Illustrative content provided by the content producer may include, but is not limited to, a movie, a movie trailer, a television show, an animation, a commercial, a screenplay, a literary work, and/or the like.

A content producer user 125 may submit content to the system for consideration. If selected, such content may be placed on the system for industry viewing, critiquing, and/or acquisition. Content producer users 125 particularly may use one or more analytics/tracking tools to track performance of the content, popularity of the content, and/or inputs regarding the content, as described in greater detail herein.

The educator/student user 130 is generally a user with an educational interest in the various content produced by a content producer user 125. Thus, in some embodiments, the educator/student user 130 may be a person affiliated with a school or a university, an arts foundation, a cultural trust, a museum, and/or the like. An educator/student user 130 may require association with an institution that has established an account with the system for particular courses. In some embodiments, student users 130 may share messages with classmates and establish new relationships/contacts with other student/faculty members in others' institutions across the country. Student users 130 may view and apply for jobs posted by companies that have a presence on the system and those that may not via, for example, a third-party application programming interface (API).

An administrative user 115 is generally a user that operates and/or maintains the system 105. The system 105 may generally be one of the various systems described herein. Thus, the system 105 may be an electronic device, a computing device, and/or one or more components thereof. The system 105 may be associated with a database 110 that is configured to contain data relating to the various users, various content, and/or the like.

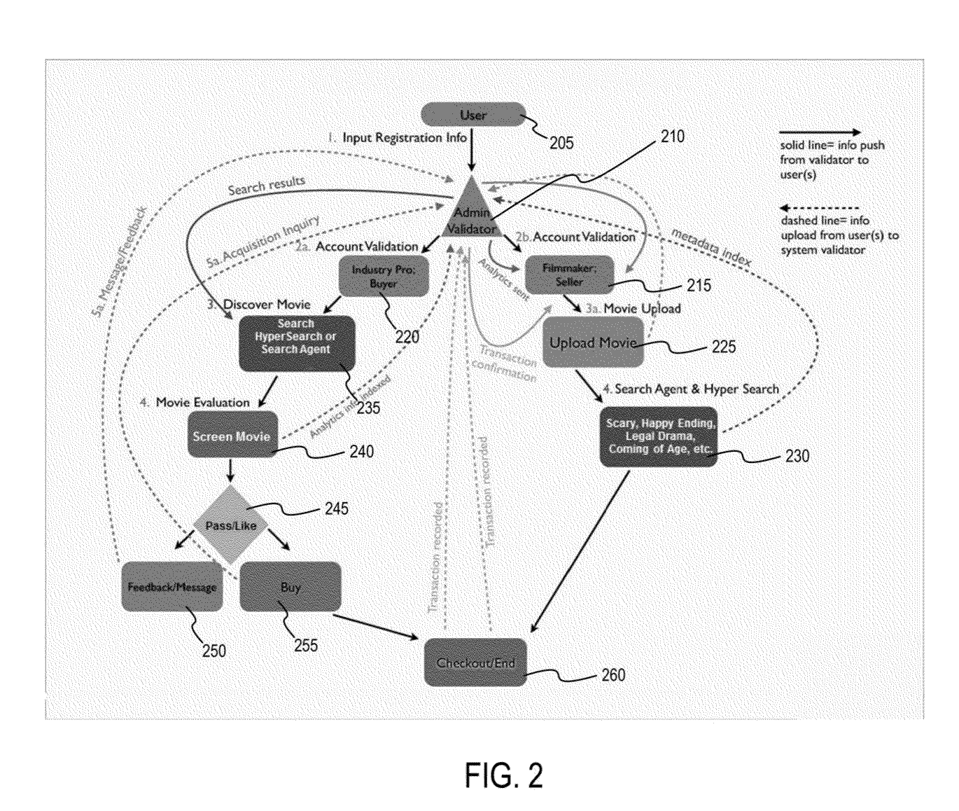

FIG. 2 depicts a flow diagram of an illustrative overview of the various processes that may be completed, as described in greater detail herein. In some embodiments, as shown in FIG. 2, a user may register 205 and an administrative user may validate 210 the user as a content producer/seller 215 or an industry professional/buyer 220. If the user is a content producer/seller, the user may upload 225 content and provide 230 descriptive keywords of the content. If the user is an industry professional/buyer, the user may search 235 for content, view 240 the content and decide 245 whether the content meets the user's needs. The industry professional/buyer may also provide 250 feedback and/or message the seller, even if such industry professional/buyer does not decide to obtain the content and/or rights to the content. In addition, the industry professional/buyer may purchase 255 the content and/or rights to the content, which is completed via a checkout function 260.

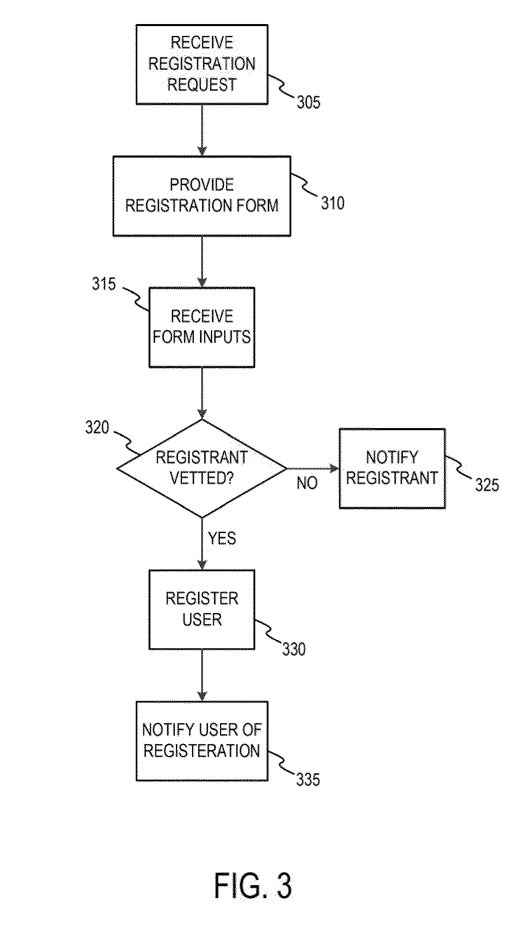

FIG. 3 depicts an illustrative flow diagram of a method of registering any user described herein to use the system. Thus, the method may apply equally to each of the users described herein, except where specifically mentioned otherwise. The method may include receiving 305 a registration request from a registrant that desires to become a user. In some embodiments, the registration request may include a registrant visiting a website and/or clicking a link to a registration form to register. The registrant may be provided 310 with a registration form. The registration form may include any number of required and/or non-required requests for information in order to register the registrant. For example, the registration form may request information regarding a user's “role” (e.g., a user type) in a relevant industry (e.g., the motion picture industry). As previously described herein, the user's role may be, for example, a content producer (e.g., a filmmaker a producer, a director, or a writer), an industry professional (e.g., a studio executive, a TV executive, a talent agent, a manager, a PR representative, a film festival organizer, or a sales agent), or an educator/student (e.g., a faculty member or a student).

The method may include receiving 315 information via the registration form and determining 320 whether the registrant is vetted. Determining 320 whether the registrant is vetted may include conducting research about the registrant to verify the information received from the registrant. Such determining 320 may be completed automatically according to a vetting algorithm or may be completed via one or more inputs from an administrator that vets the registrant. For example, communication may be initiated with the registrant, such as via telephone, to ensure the registrant is who their registration information suggests. In another example, vetting may include biometric screening, verifying documents (such as driver's licenses, credit cards, and/or the like), researching information, and/or the like. Vetting each registrant may ensure positive identification and credible industry presence. If a registrant is not vetted, the registrant may optionally be notified 325 of such action. In some embodiments, the registrant may be provided with an opportunity to provide additional information or proof of identity and/or authorization to access the system described herein. If the registrant is vetted, the registrant may be registered 330 as a user, particularly one of the types of users described in greater detail herein. The user may be notified 335 of successful registration, whereupon the user may be provided access to the system, as described herein. Once vetted and registered 330, the user's experience may vary depending on the user type selected, as described herein. For example, an industry professional user may have a user experience that differs from a content producer user because the industry professional is able to search for and view content, whereas a content producer user may only upload content and review analytics.

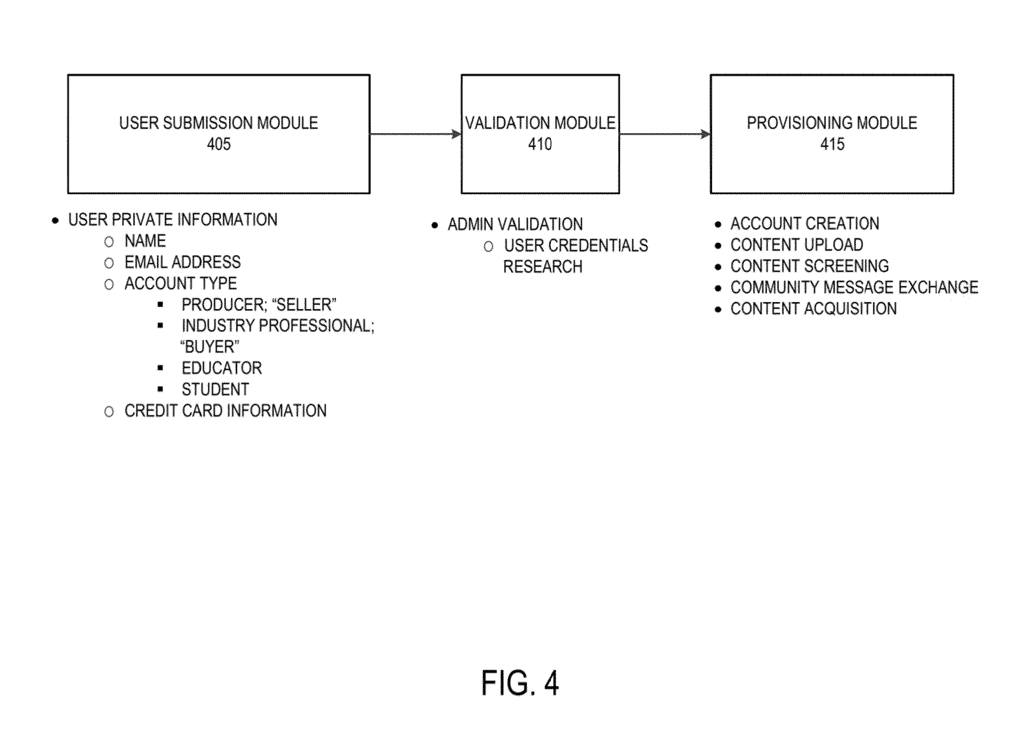

FIG. 4 depicts a flow diagram of various software modules for carrying out the processes described with respect to FIG. 3 according to an embodiment. A user submission module 405 may generally contain processes for obtaining registrant information and, after vetting, user information. A validation module 410 may generally contain processes for vetting a registrant. A provisioning module 415 may generally contain processes for creating an account and registering a user. The provisioning module 415 may also contain processes for allowing a user to upload content, allowing a user to screen content, and/or providing a community message exchange, as described in greater detail herein.

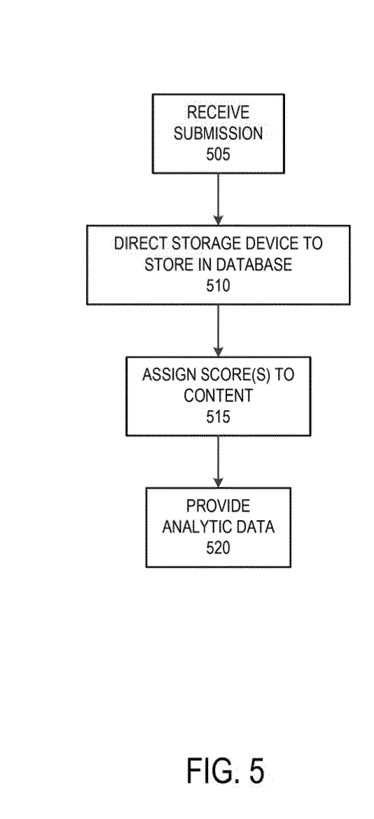

FIG. 5 depicts a flow diagram of a method of managing content from one or more users according to an embodiment. The method may include receiving 505 one or more submissions from a user. A submission may generally contain content, such as, for example, individual films/movies, movies trailers, television shows, animations, screenplays, literary works, and/or the like. In some embodiments, the submission may contain at least a portion of a user's portfolio. In some embodiments, the submission may include a name of the content, one or more names associated with the content, contact information (which may be included as a portion of the user registration), and/or other information regarding the content. In some embodiments, the submission may include a description of the content. For example, a user may provide one or more descriptive keywords that describe or tag content. Illustrative descriptive keywords may include, for example, ‘Happy Ending’, ‘Period Piece’, ‘High-Adrenaline’, ‘Musical’, ‘Crime Action’, ‘Spy’, ‘Goofy Comedy’, ‘Romance’, ‘Legal Drama’, and/or the like. The user may select as many applicable keywords as necessary, may be limited to a particular number of keywords, or may be required to select a particular number of keywords. For example, a limit of 20 keywords may be used. In some embodiments, a submission may be received 505 from any user, including the users described herein with respect to FIG. 1.

The submission, once received 505, may be stored in a database. In some embodiments, a processing device may direct 510 a storage device to store the submitted content in a database. One or more scores may be assigned 515 and/or determined for the content. In some embodiments, for example, an administrative user may review received 505 content and may direct the content to be assigned 515 a particular score based upon the review. In other embodiments, the system may automatically assign 515 a score based upon an algorithm. Thus, for example, the system may assign 515 content a number score that is based on various “tonal/emotional” categories. This number score may be stored in a back-end administrator panel for each content piece that is accepted. Illustrative categories and indices may include, but are not limited to, Funny 0-100, Serious 0-100, Pacing (Slow-Fast) 0-100, Emotional 0-100, Comical 0-100, Scary 0-100, and Optimistic 0-100. In an illustrative example, a final score of “47” for a given film on a given category (e.g., Serious) may be placed on a scoring meter between 40-50. As will be described in greater detail herein, if a user requests content that is ‘Serious’ between a 40-50 score/point range, then that particular content and other content matching that range will be displayed in real-time to the user. Applying such an algorithm to all of the content and providing control to the user may allow for the user to obtain a specific search result.

Content producers may be provided 520 with analytic data, thereby allowing the user to view a performance of the content once it has been searched for and/or viewed. The analytic data may allow content producers to access granular information such as, for example, who (e.g., which other user(s)) has viewed their content, how much of the content has been viewed, whether inputs (such as reviews or messages) have been received regarding the content, what date it was viewed, what portions of the content was viewed, whether the entire content or a trailer was viewed, and/or an affiliated company of the user that viewed the content. In some embodiments, the analytic data may be represented by a graphical line chart, which may be accessible only by a content producer. Content producers may also view a macro performance which provides a number of times the content has been viewed, a date and time the content was viewed, one or more inputs provided by a user viewing the content, and/or a number of times that the content has been viewed in a particular percentage of the content. Thus, for example, the content producer may view how many times about 1% of the content has been viewed, about 10% of the content has been viewed, about 25% of the content has been viewed, about 50% of the content has been viewed, about 75% of the content has been viewed, about 100% of the content has been viewed, or any value or range between any two of these values (including endpoints). In some embodiments, content producers may also view additional information such as, for example, all activity completed on a video player. Illustrative activity may include, but is not limited to, fast forward, pause, scrub, stop, rewind, and/or the like. In some embodiments, the activity may be rated on a scale of about 0% to about 100%. The additional information may be displayed to a content producer in graphical form, such as, for example, a line graph. The additional information may allow the content producer to gauge a possibility/likelihood of potential interest in content that may lead to an acquisition outcome.

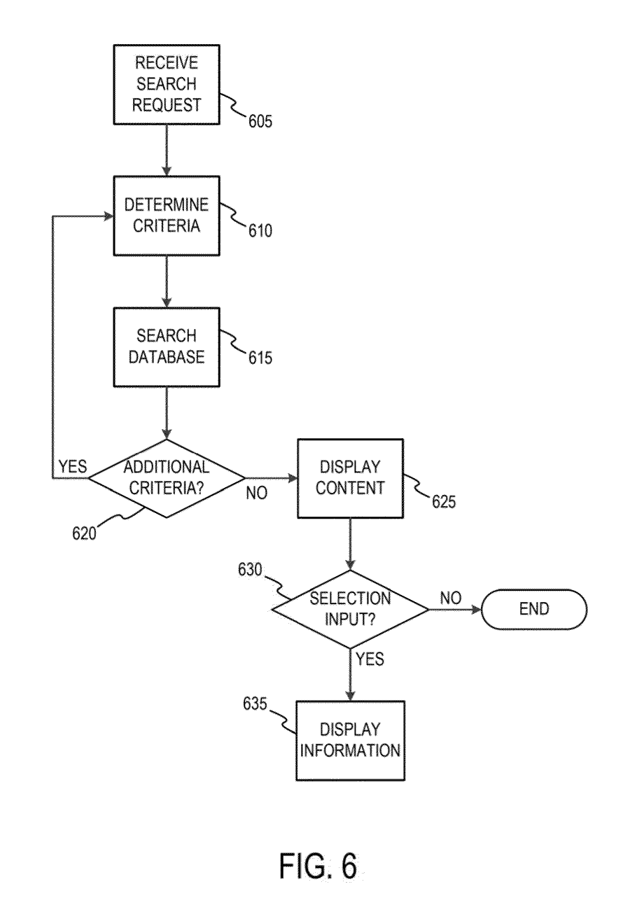

FIG. 6 depicts a flow diagram of a method for receiving and responding to search requests according to an embodiment. Such a method may be embodied, for example, in a search agent module. The search agent module may generally allow an industry professional user to automatically receive an exact genre or category of film in which they are interested. The method may include receiving 605 a search request. In some embodiments, the search request may be received 605 from an industry professional user. In other embodiments, the search request may be received 605 from another user.

The search request may generally include a description of content the user wishes to obtain. In some embodiments, a user may select descriptions of content from the same set of descriptive keywords described above with respect to process 505 (FIG. 5). In other embodiments, a user may provide his/her own descriptions of content desired. Thus, the desired criteria may be determined 610, and the database may be searched 615 for content that matches at least a portion of the desired criteria. In some embodiments, determining 610 and searching 615 may be completed automatically, even when the user is not logged in. Thus, for example, whenever new content is uploaded and accepted that matches one or more keywords from a search request, the requesting user may receive an email or mobile notification alerting them of the match, the names of the films and links within the notification, which may bring the user to a search agent results page. Thus, multiple search requests may be received 605 from a user, and no limit to the number of search requests may exist. Thus, a user may make multiple search requests to obtain a variety of different content. Accordingly a determination 620 may be made as to whether additional criteria exists based on the search request, and if so, the criteria may be determined 610, and the database may be searched 615. If no additional criteria exists, the content may be displayed 625 to the user for viewing. The content may be monitored for analytical purposes to determine whether the user views the content, whether the user views only a portion of the content, whether the user views all of the content, whether the user provides inputs such as feedback or direct messaging to the content producer, whether the user forwards the content to other users, whether the user tags the content (for example, a star rating or a thumbs up/thumbs down rating, and/or a descriptive category/keyword), whether the user activates any manipulation tools while viewing the content (for example, starting, stopping, scrubbing, pausing, seeking, ending, positioning, fast forwarding, rewinding), and/or the like, as described in greater detail herein.

In some embodiments, a determination 630 may be made as to whether the user wishes to select the content. The content may be selected, for example, if the user is interested in purchasing the content, contacting an associated user, and/or the like, as described in greater detail herein. If a user selects the content, information may be displayed 635 such that the user can contact the content provider.

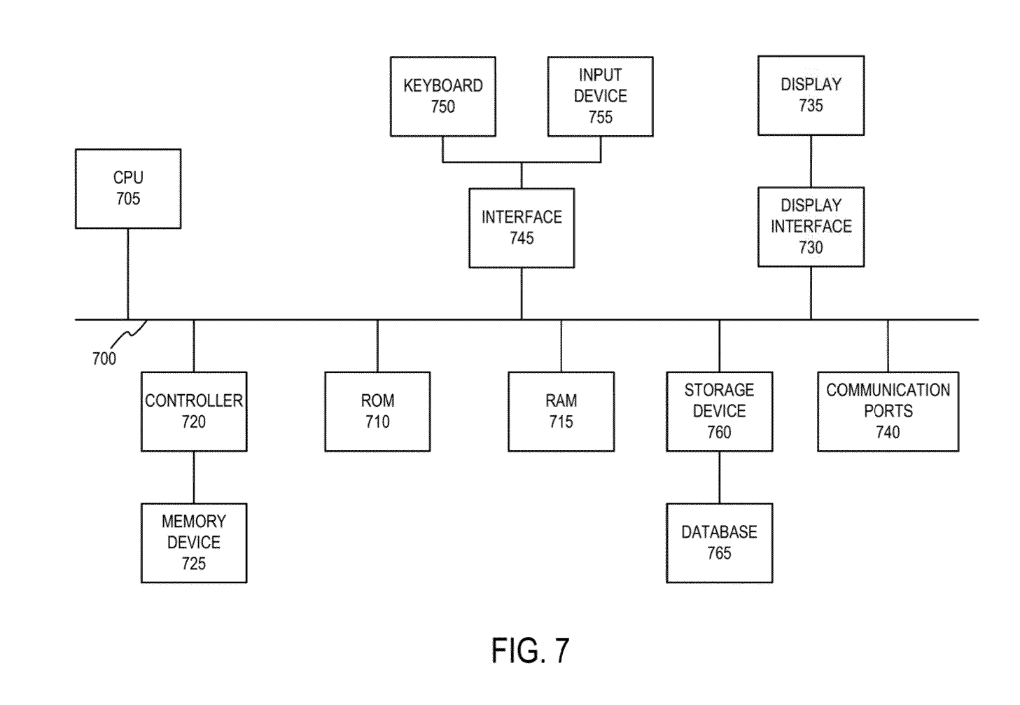

FIG. 7 depicts a block diagram of illustrative internal hardware that may be used to contain or implement program instructions, such as the process steps discussed herein, according to various embodiments. A bus 700 may serve as the main information highway interconnecting the other illustrated components of the hardware. A CPU 705 is the central processing unit of the system, performing calculations and logic operations required to execute a program. The CPU 705, alone or in conjunction with one or more of the other elements disclosed in FIG. 7, is an illustrative processing device, computing device or processor as such terms are used within this disclosure. Read only memory (ROM) 710 and random access memory (RAM) 715 constitute illustrative memory devices (i.e., processor-readable non-transitory storage media).

A controller 720 interfaces with one or more optional memory devices 725 to the system bus 700. These memory devices 725 may include, for example, an external or internal DVD drive, a CD ROM drive, a hard drive, flash memory, a USB drive, or the like. As indicated previously, these various drives and controllers are optional devices.

Program instructions, software, or interactive modules for providing the interface and performing any querying or analysis associated with one or more data sets may be stored in the ROM 710 and/or the RAM 715. Optionally, the program instructions may be stored on a tangible computer-readable medium such as a compact disk, a digital disk, flash memory, a memory card, a USB drive, an optical disc storage medium, such as a Blu-ray™ disc, and/or other non-transitory storage media.

An optional display interface 730 may permit information from the bus 700 to be displayed on the display 735 in audio, visual, graphic, or alphanumeric format. Communication with external devices, such as a print device, may occur using various communication ports 740. An illustrative communication port 740 may be attached to a communications network, such as the Internet, an intranet, or the like.

The hardware may also include an interface 745 which allows for receipt of data from input devices such as a keyboard 750 or other input device 755 such as a mouse, a joystick, a touch screen, a remote control, a pointing device, a video input device and/or an audio input device.

The hardware may also include a storage device 760 such as, for example, a connected storage device, a server, and an offsite remote storage device. Illustrative offsite remote storage devices may include hard disk drives, optical drives, tape drives, cloud storage drives, and/or the like. The storage device 760 may be configured to store data as described herein, which may optionally be stored on a database 765. The database 765 may be configured to store information in such a manner that it can be indexed and searched, as described herein.

The computing device of FIG. 7 and/or components thereof may be used to carry out the various processes as described herein.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

What is claimed is:

1. A method comprising:
receiving, by a processor, one or more content submissions from one or more first users, wherein the one or more content submissions comprise one or more of the following: a name, contact information, content, information regarding the content, and one or more descriptive keywords regarding the content;
directing, by the processor, a storage device to store the one or more content submissions in a database configured to be indexed for searching one or more search criteria based upon the one or more content submissions;
receiving, by the processor, one or more search requests from each of one or more second users, wherein each search request comprises one or more request criteria corresponding to a desired search result;
for each of the one or more second users:
searching, by the processor, the database for one or more search criteria that correspond to the one or more request criteria to obtain one or more content submissions;
directing, by the processor, a display to display the one or more content submissions;
receiving, by the processor, a selection input, wherein the selection input corresponds to an indication by the second user that one of the one or more content submissions is desired; and
directing, by the processor, the display to display information corresponding to the desired content submissions.

2. The method of claim 1, wherein the one or more search criteria comprises a number score for each of a plurality of categories, wherein the number score corresponds the information regarding the content.

3. The method of claim 2, wherein the number score is on a scale that ranges from 1 to 100.

4. The method of claim 2, wherein the plurality of categories are selected from a list of the following: funny, serious, pacing, emotional, comical, scary, and optimistic.

5. The method of claim 1, wherein the content comprises a movie, a movie trailer, a television show, an animation, or a commercial.

6. The method of claim 1, further comprising providing, by the processor, analytic data to each of the one or more first users, wherein the analytic data comprises one or more of the following: information regarding an identity of a second user, information regarding an identity of other users, information regarding an identity of a company a second user or other users work for, a total number of users that have viewed the content, an amount of the content that was viewed, a date and time the content was viewed, and one or more inputs provided by a second user and/or other users.

7. The method of claim 1, wherein at least one of the one or more first users is a content producer selected from one or more of a filmmaker, a producer, a director, a writer, an actor, a photographer, and a crew member.

8. The method of claim 1, wherein at least one of the one or more second users is an industry professional user.

9. A system for providing a networked evaluation, the system comprising:
a storage device configured to store one or more content submissions in a database configured to be indexed for searching one or more search criteria based upon the one or more content submissions;
a processor; and
a non-transitory, processor-readable storage medium in communication with the processor, wherein the non-transitory, processor-readable storage medium comprises one or more programming instructions that, when executed, cause the processor to:
receive the one or more content submissions from one or more first users, wherein the one or more content submissions comprise one or more of the following: a name, contact information, content, information regarding the content, and one or more descriptive keywords regarding the content;
direct the storage device to store the one or more content submissions in the database;
receive one or more search requests from each of one or more second users, wherein each search request comprises one or more request criteria corresponding to a desired search result;
for each of the one or more second users:
search the database for one or more search criteria that correspond to the one or more request criteria to obtain one or more content submissions;
direct a display to display the one or more content submissions;
receive a selection input, wherein the selection input corresponds to an indication by the second user that one of the one or more content submissions is desired; and
direct the display to display information corresponding to the desired content submissions.

10. The system of claim 9, wherein the one or more search criteria comprises a number score for each of a plurality of categories, wherein the number score corresponds the information regarding the content.

11. The system of claim 10, wherein the number score is on a scale that ranges from 1 to 100.

12. The system of claim 10, wherein the plurality of categories are selected from a list of the following: funny, serious, pacing, emotional, comical, scary, and optimistic.

13. The system of claim 9, wherein the content comprises a movie, a movie trailer, a television show, an animation, or a commercial.

14. The system of claim 9, wherein the non-transitory, processor-readable storage medium further comprises one or more programming instructions that, when executed, cause the processor to provide analytic data to each of the one or more first users, wherein the analytic data comprises one or more of the following: information regarding an identity of a second user, information regarding an identity of other users, information regarding an identity of a company a second user or other users work for, a total number of users that have viewed the content, an amount of the content that was viewed, a date and time the content was viewed, and one or more inputs provided by a second user and/or other users.

15. The system of claim 9, wherein at least one of the one or more first users is a content producer selected from one or more of a filmmaker, a producer, a director, a writer, an actor, a photographer, and a crew member.

16. The method of claim 9, wherein at least one of the one or more second users is an industry professional user.
